(19) United States
(12) Patent Application Publication
(10) Pub. No.: US 2011/0186150 A1
(43) Pub. Date: Aug. 4, 2011

(54) AIR DISTRIBUTION SYSTEM, FLOW RESTRICTOR AND CONTROL SYSTEM

(75) Inventor: Georg Garbers, Hamburg (DE)

(73) Assignee: AIRBUS OPERATIONS GMBH, Hamburg (DE)

(21) Appl. No.: 13/013,863

(22) Filed: Jan. 26, 2011

Related U.S. Application Data
(60) Provisional application No. 61/299,414, filed on Jan. 29, 2010.

(30) Foreign Application Priority Data
Jan. 29, 2010 (DE) 10 2010 006 147.6

(51) Int. Cl. F16K 15/00

(52) U.S. Cl. 137/511

(57) ABSTRACT

An air distribution system comprises at least one air conduit, at least one air outlet, at least one flow restrictor, at least one sensor for acquiring an air state and at least one control unit. The air outlet is connected to the air conduit, the flow restrictor is positioned on the air conduit, and the control unit is connected to the sensor. The control unit is designed, in the case of any deviation of a measured air state at the air outlet from a predetermined desired air-state, to cause the flow restrictor to vary its aperture cross section. In particular in the case of air distribution systems comprising a multitude of air outlets efficient and quick trimming can take place in this manner.

### CROSS-REFERENCE TO RELATED APPLICATIONS

This application claims the benefit of the filing date of U.S. Provisional Patent Application No. 61/299,414 filed Jan. 29, 2010, the disclosure of which application is hereby incorporated herein by reference.

### BACKGROUND OF THE INVENTION

The invention relates to an air distribution system, a flow restrictor for a fluid conduit, a control system for trimming an air distribution system in a vehicle, and to an aircraft.

In air-conditioned spaces where people are present, used air is often removed and fresh air is fed into the space. In particular in the case of larger spaces it is impractical to feed air into the space through only a single air inlet so that preferably in such cases several air outlets are used which are connected to one or to a few shared air sources.

In order to homogenise the climate and the air movement in the space it is frequently desirable for all the air outlets to convey air into the space, for example, as far as possible with identical volume flows. If, for example, a single central air source is used that is connected to all the air outlets in the space, in order to achieve identical air volume flows at all the outlets, measures are necessary to prevent a situation at the air outlets in close proximity to the air sources whereby in those locations a larger air volume flow is discharged than is the case at air outlets that are located further away from the air source. This may be ensured by the selection of different conduit diameters; however, the restrictors are used to calibrate the system because even with elaborate computer-based determination the actual air volume flows cannot be predicted in a completely accurate manner.

This object may be ensured by flow restrictors or other resistance-increasing elements that are situated in the feed lines to the individual air outlets, and depending on the position of the respective air outlet as well as the conditions specific to the space are individually designed. For example, if at a shared air conduit several air outlets are arranged, in the case of unchanged conduit cross sections a greater flow restriction may be necessary the closer the corresponding air outlet is to the air source. Moreover, if the cross section of the shared air conduit varies between the air source and the farthest air outlet, further variations in individual resistance might become necessary.

For example, modern commercial aircraft comprise one or several air distribution systems with a multitude of air outlets that are connected to a central air source, for example a central mixer unit for mixing stale cabin air with fresh air from a fresh-air source, which air distribution systems need to meet requirements of essentially providing identical air volume flows for homogenisation of the air supply flow and the local temperatures. To this effect, apertured orifices are usually used which individually increase the resistance to the air outlets, which resistance is to be overcome by the air. Depending on the corresponding design of the aircraft cabin and of the design of the regions comprising the air outlets, the air outlets are of different designs, different dimensions and in some cases are irregularly positioned. For “trimming” an air distribution system in an aircraft it is therefore necessary to experimentally determine all the flow restrictor geometries by means of which, for example, identical air volume flows may be implemented. However, since aircraft cabins are generally reconfigured or are very individually designed by aircraft operators, and may also be constantly changed in the course of the service life of an aircraft, there may be a necessity for an air distribution system that has been trimmed in a one-off operation to be adjusted again in an experimental manner so that it may reflect new conditions. While a base configuration of an aircraft type may be trimmed in an experimental structure, for example in a mock-up, in the case of any change in an already installed air distribution system only renewed investigation on the aircraft itself is feasible.

DE 43 08 466 C1 and U.S. Pat. No. 5,479,983 show an aircraft air conditioning system comprising an air distribution system with a number of air outlets.

Furthermore, DE 10 2007 001 052 A1 and US 2008/0156385 A1 show a restrictor system for use in an air conditioning system, in particular in an aircraft air conditioning system.

### BRIEF SUMMARY OF THE INVENTION

Experimental determination of suitable restrictor cross sections, and manual trimming of complex air distribution systems are burdensome. Furthermore, a manually trimmed air distribution system may always only be trimmed in relation to a particular state of the space to be air conditioned, and consequently it is not feasible to adjust it to changed conditions in the space, for example pressure conditions or temperature conditions, or to varying requirements concerning the air distribution during operation.

It may thus be the object of the invention to propose an air distribution system that overcomes the above-mentioned disadvantages and that allows trimming in the most effective manner possible while, furthermore, being implementable as quickly as possible.

It may be a further object of the invention to propose such an air distribution system that furthermore may very easily be adapted to changed conditions in the space or to varying requirements relating to the air distribution during operation.

A further object of the invention may be to propose an air distribution system that is suitable for use in an aircraft, which air distribution system may be trimmed very effectively and quickly, independently of the respective design or variation of the aircraft cabin of the aircraft operator.

The objects may be met by an air distribution system with the characteristics of the independent claim 1. Advantageous improvements are shown in the subordinate claims.

According to a first aspect of the invention, the air distribution system comprises at least one air conduit, at least one air outlet and at least one flow restrictor, wherein the air outlet is connected to the air conduit, and the flow restrictor is positioned on the air conduit in order to exert flow resistance to the airflow flowing to the air outlet. The flow restrictor is furthermore designed to vary an aperture cross section between a minimum-aperture cross section and a maximum-aperture cross section, wherein the flow restrictor is connected to a control unit that is designed to cause the flow restrictor to vary the aperture cross section. The control unit itself is connected to at least one sensor for determining an air state. The sensor may be positioned in the space to be air conditioned or on the air conduit. The control unit is preferably designed to compare the air state determined by the sensor with a desired air-state, and in the case of a deviation from the desired air-state to open or close the flow restrictor.

The air distribution system according to the invention is thus able to set a flow restrictor in such a manner that a desired air-state through the respective air outlet that follows downstream of the flow restrictor is produced. In this arrangement the measured air state may be of a manifold nature. Apart from a desired air volume flow provided through the air outlet, it would also be possible to measure the air pressure present at, in, in front of or behind the respective air outlet as the air state to be set. This may either be an absolute pressure or a differential pressure which is, for example, measured over the air outlet. With a knowledge of the differential pressure and with a knowledge of an experimentally simple determinable flow resistance of the air outlet the achieved air volume flow may be calculated. Furthermore, the air state that is measured by the sensor may also be an air temperature that is determined at a suitable distance from the air outlet. For example, if the air flowing from the air outlet is used not only to freshen up the air in a space but also to adjust its temperature, a measured air temperature may provide information about the desired outflow of the air from the air outlet.

However, the invention is not at all limited to only a single air outlet, a single flow restrictor and a single air conduit. Instead, the air distribution system according to the invention is particularly suitable for a multitude of air outlets which thus require a multitude of flow restrictors and are connected by way of a multitude of air conduits, for example to a central air source. For example, by measuring air volume flows, differential pressures or temperatures at each air outlet, as a result of individual comparisons of the measured value with corresponding desired values it may be ensured that at each air outlet an identical air volume flow, an identical differential pressure or an identical achieved temperature in the respective space section are set.

In this arrangement the control unit that is connected to the sensor or sensors should essentially master a control strategy that makes possible individual setting of the flow restrictors. In order to influence a change in the aperture cross sections of the flow restrictors, for example an electrical signal may be used that is transmitted to an actuator or the like that may be positioned on a flow restrictor where it would adjust the aperture cross section. If a single sensor and a single air outlet are used, the control strategy is relatively simple. For example a simple PID controller with an adequate time constant may be sufficient to obtain the desired air state.

If a multitude of air outlets, sensors and flow restrictors are used, the control strategy is preferably implemented as a multivariable control process in which the states of all the individual flow restrictors exert a more or less extensive influence on the achieved air states at each air outlet. If, for example, at a shared air conduit with a number of air outlets a number of flow restrictors are used whose aperture cross sections are adjustable, it is possible, for example, for the air outlet situated closest to the air source to let out of the air conduit a large part of the available air when the flow restrictor opens up, while each of the air outlets that are arranged downstream in each case only have a small proportion of the air available for letting out. This effect may be reinforced if the aperture cross sections of the flow restrictors that are located further away from the air source are reduced, while the aperture cross sections of the flow restrictors that are located closer to the air source are increased. However, this effect will be reduced if the aperture cross section of the flow restrictor that is arranged nearer to the air source is reduced, while the opening cross sections of the downstream flow restrictors, which are further away, are in each case increased. The interaction of the aperture cross sections of all the flow restrictors needs to be taken into account in the dynamics of control so that for this purpose PID controllers with relatively high time constants would suggest themselves, which do not lead to the swinging-up of individual flow restrictors, wherein, in addition to finding a sensible starting point for the control, a previously known experimental state matrix relating to all the flow restrictors may be used, which state matrix may alternatively also be determined by numerical simulation.

It is the object of such an air distribution system according to the invention to bring about autarchic trimming, which takes place automatically, of the air distribution system, which is to result in homogeneous air states at a number of air outlets that feed air into a space.

In an advantageous embodiment the flow restrictor comprises an electric actuator that for the purpose of varying the aperture cross section of the flow restrictor is connected to an adjustment mechanism at the flow restrictor. In this manner an electrical connection between a flow restrictor and the control unit may be established, and in an installed state, for example in an air conduit, the aperture cross section of the flow restrictor is remotely controllable from the outside.

In an advantageous embodiment the sensor is arranged on the flow restrictor. In this arrangement the sensor may be an absolute pressure sensor, a differential pressure sensor or an air-volume flow sensor. The absolute pressure sensor may, for example, be arranged upstream of the flow restrictor, while a differential pressure sensor may acquire the differential pressure between an upstream and a downstream side of the flow restrictor. An air-volume flow sensor may be arranged either upstream or downstream of the flow restrictor.

In an advantageous embodiment the flow restrictor comprises a sensor for acquiring the opening state. This sensor may, for example, be designed in such a manner that the relative positions of two flow restrictor components that are movable relative to each other are determined and, based on the knowledge of the geometric design of the flow restrictor, may be determined by way of the relative position of the respective aperture cross section. Consequently an additional state variable for the control unit is available, which may, for example by means of experimentally determined flow restrictor sizes, be made comparable to known realistic, physical limit values. This may result in better support of the control process or in an increase in the reliability because in this way, for example, nonsensical values or strong deviations from aperture cross sections of adjacent air outlets may be excluded. Consequently the control system tends to be associated even less with oscillation phenomena.

In an advantageous embodiment the sensor is designed as a differential pressure sensor that determines the differential pressure between an upstream and a downstream side of the flow restrictor, wherein the control unit is designed, from the additional knowledge of the aperture cross section at the time, by way of the determined differential pressure to determine the air volume flow at that instant. Consequently it would be obsolete to position additional sensors with additional cabling at a location other than at an actuator or the like in or on the air conduit, so that the complexity of the air distribution system according to the invention may be optimised by aggregating electrical lines or installation ducts.

In an advantageous embodiment the flow restrictor comprises a wireless transmitter and receiver unit and is further designed to be supplied with electrical energy by an external power supply. In this arrangement the external power supply may be implemented in the form of an energy storage device, e.g. a battery, or as an alternative by means of a current source that is already present in the space. To this effect there is no need to provide wiring between a control unit positioned centrally in the space and flow restrictors that might possibly be at quite some distance of the former, so that, for example, only relatively short electrical feed lines to flow restrictors distributed within the space would be necessary.

In an advantageous embodiment the control unit is designed to determine the air pressure of the air source, which air pressure is necessary for operating the air distribution system with predetermined air states, and at a second signal output to provide a signal that represents this air pressure. This results in the output of the air source being controllable by means of a connection of this second signal output with a conveying device, a compressor or the like.

In an advantageous embodiment the control unit is furthermore equipped, if necessary, to set an alternative desired air-state that may be activated from the outside by way of the flow restrictor. For example if it is necessary only on particular days, at particular times or in particular temperature conditions to provide stronger ventilation than in other situations, the control unit may, for example, cause the flow restrictor during this alternative desired air-state to provide a different air volume flow through the respective air outlet. The requirement for switchover may be triggered by means of an external signal that may be acquired by the control unit at a second signal input.

In an advantageous embodiment the control unit comprises at least one storage unit that is designed for storing and subsequent retrieving the state of the flow restrictor. This provides an advantage in that already flow restrictor settings for various desired air-states, which flow restrictor settings have already been determined at earlier points in time by control the air distribution system according to the invention, are stored in relation to various desired air-states, and later on, during switching between various desired air-states without controlling to be carried out, the flow restrictor may return to an already known advantageous flow restrictor position. This is advantageous in particular in the case of a substantial number of flow restrictors, because such adjustment of the flow restrictors may take place significantly more quickly than is the case with control by means of state variables.

A flow restrictor is also in a position to meet the object of the invention. A flow restrictor according to the invention may, for example, comprise two or more restrictor parts that are movable relative to each other, which restrictor parts by means of their relative movement influence the aperture cross section of the flow restrictor according to the invention. According to one aspect of the invention, the flow restrictor additionally comprises an electrical actuator that may comprise a signal output. This signal output may be connected to a control unit so that a signal transmitted from the control unit to the flow restrictor according to the invention results in activation of the actuator and thus in influencing the aperture cross section of the flow restrictor.

In an advantageous embodiment the flow restrictor additionally comprises a position sensor that may acquire the relative positions of the two or more restrictor parts relative to each other and may provide them at a signal output. By evaluating the position signal a control unit may determine the aperture cross section that exists at the time, so that, for example, a comparison with previously experimentally determined aperture cross sections or a delimitation of aperture cross sections for particular operating states may be prevented.

In an advantageous embodiment the two or more restrictor parts may be designed in a star-shaped manner, held on a shared shaft so as to be rotatable relative to each other, so that by means of rotation of at least one of the two or more restrictor parts the aperture cross section of the flow restrictor may be reduced or increased. This solution is mechanically very simple and reliable, wherein in this type of restrictor practically no forces act on the restrictor parts as a result of the through-flowing fluid, which forces would attempt to influence the adjustment of the aperture cross section. One restrictor part may circumferentially be firmly connected to the associated air conduit and may be held so as to be immovable. The rotary shaft may then be arranged on this immovable restrictor part.

In an advantageous embodiment the electrical actuator may be designed as an electric motor that is connected to a movably held restrictor part in order to move said part relative to another restrictor part. Electric motors may be made in very small sizes and comprise extraordinarily high reliability so that by means of this combination a practically maintenance-free adjustable flow restrictor may be provided that may alter the aperture cross section in a remotely controlled manner.

By means of a spindle gear or worm gear unit the electric motor may act radially onto a circularly symmetrical restrictor part that is rotatably held on a rotary shaft. Such a drive is preferably designed so as to be self-locking and comprises a relatively high gear ratio so that a particularly low drive torque is required and the design size of the electric motor may be selected to be very small.

In addition in an advantageous embodiment the flow restrictor according to the invention is equipped with a sensor for acquiring an air state. As already described above, this sensor may be an air-volume flow sensor or a differential pressure sensor that determines a differential pressure between two sides of the flow restrictor.

In addition, the object may be met by a control system for trimming an air distribution system that comprises characteristics and advantages described above.

Finally, the object may also be met by an aircraft comprising an air conditioning system and an air distribution system, wherein the air distribution system is connected to the air conditioning system and from it receives air for feeding into an aircraft cabin.

In an advantageous embodiment the aircraft according to the invention is designed, depending on the flight states or stopover states, to provide a desired air-state to the control unit which thereupon causes a change in the aperture cross sections of the flow restrictors and controlling of the supply-air pressure of the air conditioning system. During a stopover of the aircraft on the ground it might, for example, happen, in the case of heat conditions and one-sided solar irradiation, for one side of the cabin to heat up to a particularly great extent, which may result in reduced passenger comfort, wherein the present invention would help supply said side in a targeted manner with cool fresh air.

### BRIEF DESCRIPTION OF THE DRAWINGS

Further characteristics, advantages and application options of the present invention are disclosed in the following description of the exemplary embodiments and of the figures. All the described and/or illustrated characteristics per se and in any combination form the subject of the invention, even irrespective of their composition in the individual claims or their interrelationships. Furthermore, identical or similar components in the figures have the same reference characters.

FIG. 1 shows a diagrammatic view of the air distribution system according to the invention.

FIGS. 2a and 2b show a flow restrictor according to the invention with two different aperture cross sections.

FIG. 3 shows a block-based diagram of a method according to the invention for trimming an air distribution system according to the invention.

FIG. 4 finally shows an aircraft with at least one air conditioning system and at least one air distribution system according to the invention.

### DETAILED DESCRIPTION

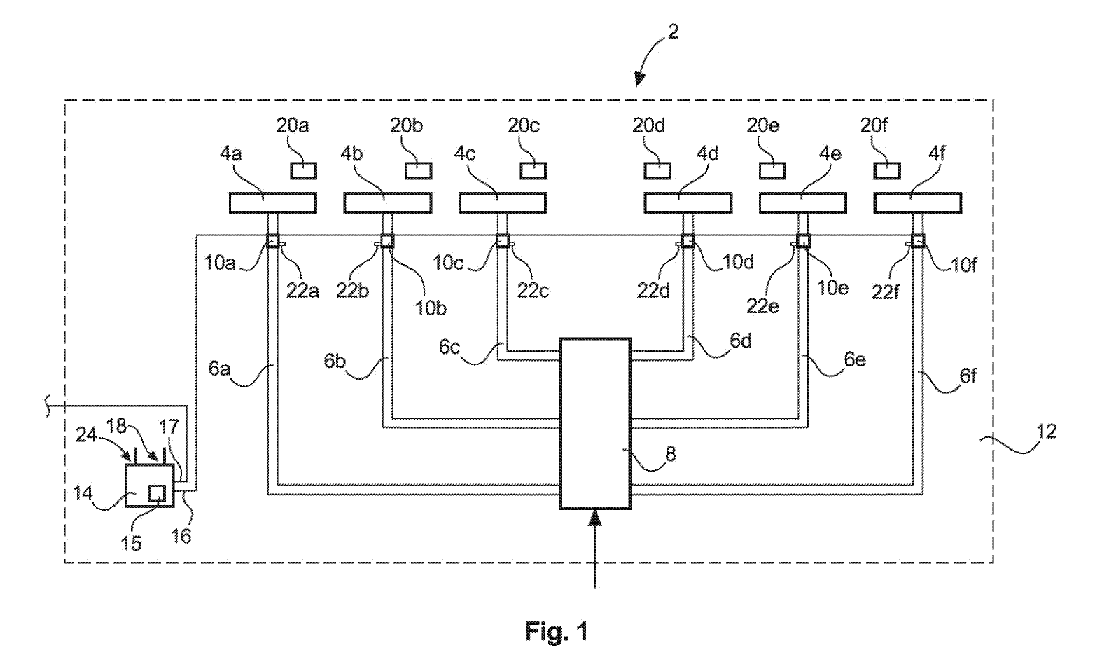

The air distribution system 2 according to the invention, which is shown in FIG. 1, comprises air outlets 4a-f which by way of air conduits 6a-6f are connected to a shared air source 8 which, for example, has been implemented in the form of a distributor or a mixer. In the air conduits 6a-6f, flow restrictors 10a-10f are arranged whose flow resistance may be influenced from the outside. The air distribution system 2 according to the invention is situated in a space 12 that is to be air conditioned. This makes it necessary for the air that enters the space 12 by way of the air source 8 and the individual air outlets 4a-4f in each case to have the same air state or in each case to lead to producing an air state that locally exists at the respective air outlet 4a-4f so that even and homogeneous air conditioning or ventilation of the space 12 becomes possible. This makes it necessary for the flow restrictors 10a-10f to be set in such a manner that, for example, from the air outlets 4a-4f in each case an identical air volume flow emanates although the line conduit lengths 6a-6f differ.

To accomplish this task the flow restrictors 10a-10f are designed in such a manner that they may alter the cross section of the throughflow aperture, for example by way of an electrically operable actuator. A control unit 14 is preferably connected to the flow restrictors 10a-10f by way of a first signal output 16, so that as a result of the emission of a suitable control signal at the first signal output 16 the individual flow restrictors 10a-10f correspondingly increase or decrease their aperture cross sections. By way of a first signal input 18, sensors 20 may be connected to the control unit 14 in order to transmit information, signals, data or the like concerning the respective air states in the region of the air outlets 4a-4f. Consequently the control unit 14 is able, with the knowledge of a desired air-state to be achieved, to influence the flow restrictors 10a-10f in such a manner that the acquired air states in the region of the air outlets 4a-4f agree with the predetermined desired air-states.

In addition, the flow restrictors 10a-10f may, furthermore, comprise their own sensors 22a-22f that provide information about the degree of opening, at that time, of the respective flow restrictor 10a-10f. These sensors 22a-22f may be connected to a second signal input 24 in order to communicate information about the degree of opening at that time to the control unit 14. With a knowledge of the geometry of the individual flow restrictors 22a-22f the control unit 14 is in a position to determine the aperture cross sections so that by means of aperture cross sections that have previously been determined in an experimental manner, with physical limit values or the like, a comparison is made possible so that nonsensical control processes may be prevented to the greatest extent possible.

The control unit 14 preferably comprises a storage unit 15 that makes it possible to store control states of flow restrictors and to provide them again later on. Thus for particular application cases already determined control states may again be converted to restrictor aperture cross sections without having to carry out the entire control process anew.

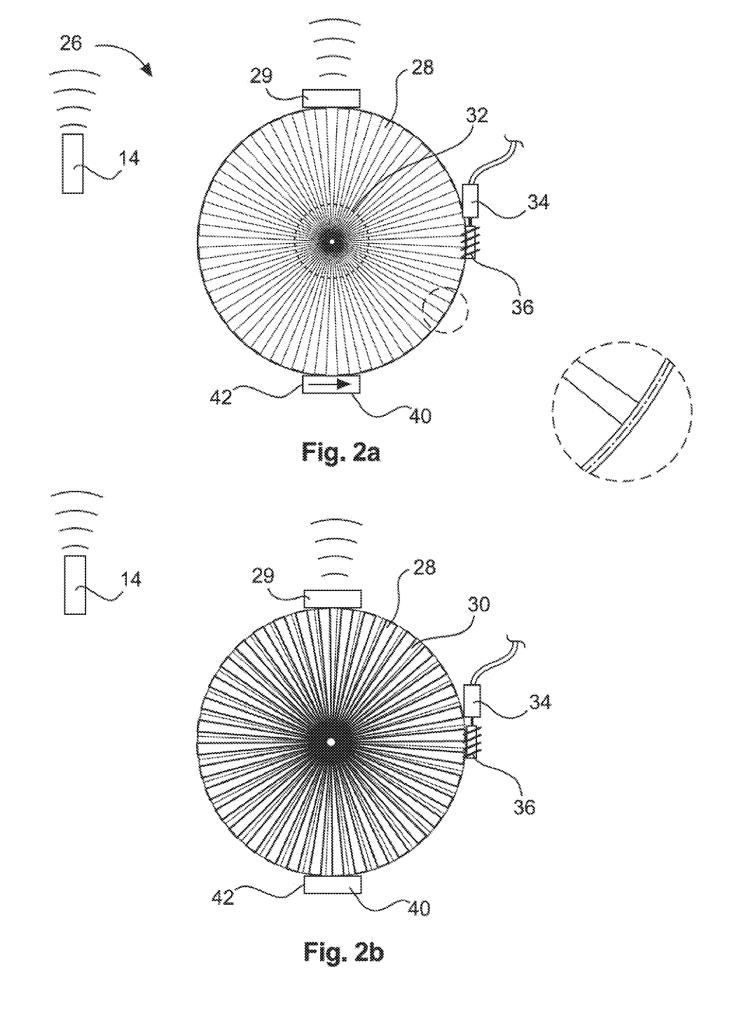

FIGS. 2a and 2b show an example of a flow restrictor 26 that comprises two restrictor parts 28 and 30 which are held, concentrically to each other, on a shaft 32, wherein at least one of the two restrictor parts 28 and 30 is movable relative to the other restrictor part 30 and 28. The two restrictor parts 28 and 30 as an example comprise a star-shaped structure in which webs and open spaces alternate. By rotation of one restrictor part 28 or 30 relative to the other restrictor part 30 or 28, in this way the resulting aperture cross section of the restrictor 26 may be increased or decreased.

Driving one of the two restrictor parts 28 or 30 may take place by means of an electric motor 34 that comprises a worm shaft 36 that engages a toothed arrangement of one of the two restrictor parts 28 or 30. The resulting worm gear may have a relatively high gear ratio as well as a self-locking device by means of which reverse rotation of the driven restrictor part 28 or 30 may be prevented, and at the same time, due to the very low torque needed, the drive motor may be dimensioned so as to be very small.

As an alternative to the above it would also be possible to provide an electric motor 38 that is arranged coaxially to the two restrictor parts 28 and 30 and that directly drives a restrictor part 28 or 30. The motor 38 may also be designed as a gear motor in which the gearing is arranged so as to be coaxial relative to the electric motor.

For determining the respective degree of opening of the flow restrictor 26 a pin 42 arranged at the sensor may be provided, as may some other type of marking that may be moved relative to the sensor 40 and that makes it possible for this relative movement to be acquired by the sensor 40.

As an example, the flow restrictor 26 comprises a wireless transmitter and receiver unit 29 that may, for example, communicate wirelessly with a control unit 14, for example in order to set a predetermined degree of opening.

It should be emphasised that below, the air distribution system according to the invention is set out merely as an example with reference to an aircraft, but that it may also be used in other vehicles or stationary equipment. The description or depiction does not limit the subject of the invention.

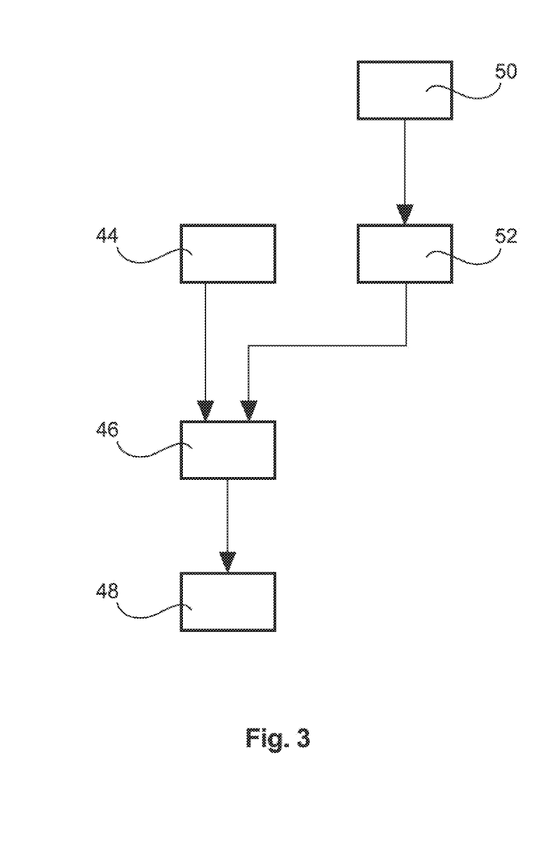

The method shown in FIG. 3 essentially comprises the steps of measuring 44 the air state, comparing the air state to the desired air-state 46, and controlling 48 the flow restrictor. In addition, the method according to the invention may comprise the step of acquiring 50 the degree of opening of the flow restrictor, of determining 52 the aperture cross section at that time, of the flow restrictor, and of comparing the aperture cross section at that time, of the flow restrictor, with a known aperture cross section.

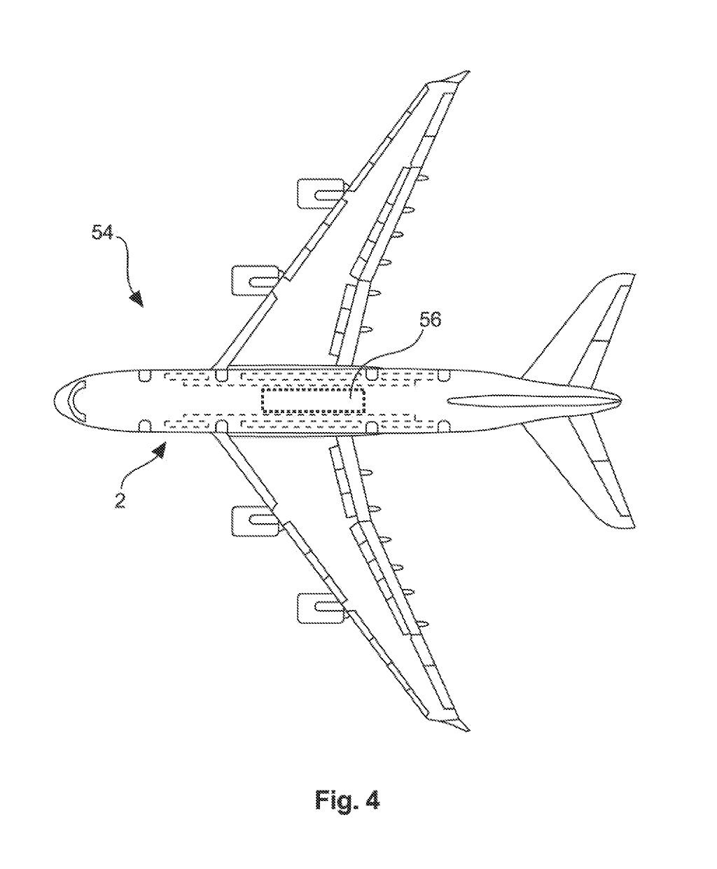

Finally, FIG. 4 shows an aircraft 54 comprising at least one air conditioning system 56 that conveys air to an air distribution system 2.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments may also be used in combination with other characteristics or steps of other exemplary embodiments described above. Reference characters in the claims are not to be interpreted as limitations.

### LIST OF REFERENCE CHARACTERS

2 Air distribution system
4a-f Air outlet
6a-f Air conduit
8 Air source
10a-f Flow restrictor
12 Space
14 Control unit
15 Control unit
16 First signal output
17 Second signal output
18 First signal input
20 Sensor
22a-f Sensor
24 Second signal input
26 Flow restrictor
28 Restrictor part
29 Wireless transmitter and receiver unit
30 Restrictor part
32 Shaft
34 Electric motor
36 Worm shaft
38 Electric motor
40 Sensor
42 Pin
44 Measuring
46 Comparing
48 Controlling
50 Acquiring
52 Determining
54 Aircraft
56 Air conditioning system

1. An air distribution system, comprising:
at least one air conduit; and
a plurality of air outlets leading into one space, each air outlet comprising a flow restrictor and a control unit;
wherein the air outlets are connected to the air conduit and the flow restrictors are positioned on the respective air outlets;
wherein the air outlets each comprise a sensor connected to the control unit, the sensor being adapted for determining an air state;
wherein the flow restrictors each are connected to the control unit, the flow restrictors each being adjustable with an actuator;
wherein the flow restrictors are designed to vary a cross section of an aperture thereof between a minimum-aperture cross section and a maximum-aperture cross section; and
wherein the control unit is designed to calibrate the air distribution system for achieving a homogenous air flow into the space during stationary operation by comparing the air state determined by all the sensors with a reference air-state; and
wherein the control unit is designed to cause the flow restrictor to change the cross section of the aperture if the air state determined by all the sensor deviates from the reference air-state.

2. The air distribution system of claim 1, wherein the flow restrictors each comprise an actuator for varying the cross section of the aperture.

3. The air distribution system of claim 1, wherein the sensors are pressure sensors.

4. The air distribution system of claim 3, wherein the sensors each are differential pressure sensors arranged on the flow restrictor, each sensor being designed to determine the differential pressure on the flow restrictor.

5. The air distribution system of claim 1, wherein the sensors are air-volume flow sensors.

6. The air distribution system of claim 1, wherein at least one of the flow restrictors comprises a sensor for determining an opening air-state to the control unit, the sensor being adapted to transmit an output signal indicative of the opening air-state to the control unit.

7. The air distribution system of claim 1, wherein at least one of the flow restrictors comprises a wireless transmitter and receiver unit and is designed to be supplied with electrical energy by an external power supply.

8. The air distribution system of claim 1, wherein the control unit is designed to determine the air pressure of an air source, the air pressure being necessary for operating the air distribution system with predetermined air states, and wherein the control unit is designed to provide an output signal that represents the determined air pressure.

9. The air distribution system of claim 1, wherein the control unit is designed to set an alternative desired air-state using the flow restrictor.

10. The air distribution system of claim 1, wherein the control unit comprises at least one storage unit designed for storing and retrieving data indicative of a state of the flow restrict or.

11. A flow restrictor for generating flow resistance in an air conduit, comprising:
first and second restrictor parts supported concentrically to each other on one axis, wherein at least one of the first and second restrictor parts is rotatable relative to the other; and
an electric actuator designed to move the first restrictor part relative to the second restrictor part in order to vary a cross section of an aperture of the flow restrictor.

12. The flow restrictor of claim 11, further comprising a sensor designed to determine the relative positions of the first and second restrictor parts relative to each other and to provide the first and second restrictor parts with an output signal.

13. The flow restrictor of claim 11, further comprising a sensor for determining an air state.

14. A control unit for calibrating an air distribution system, comprising:
a control unit designed to be connected to a plurality of sensors adapted to determine air states and to a plurality of flow restrictors each having an aperture with a variable cross section; and
wherein the control unit is designed to compare the air state determined by the sensors with a reference air-state; and
wherein the control unit is designed to cause the flow restrictor to change the cross section of the aperture if the air-state deviates from the reference air-state.

15. An aircraft comprising at least one air conditioning system and at least one air distribution system of claim 1.
